(19) United States
(12) Patent Application Publication
(10) Pub. No.: US 2010/0325726 A1
(43) Pub. Date: Dec. 23, 2010

(54) UNAUTHORIZED OPERATION MONITORING PROGRAM, UNAUTHORIZED OPERATION MONITORING METHOD, AND UNAUTHORIZED OPERATION MONITORING SYSTEM

(76) Inventors: Osamu Aoki, Tokyo (JP); Haruko Ikeda, Chiba (JP); Ryosuke Kato, Tokyo (JP)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/159,918

(22) PCT Filed: Jan. 5, 2006
(86) PCT No.: PCT/JP2006/300021

§ 371 Date: Sep. 30, 2009

(51) Int. Cl. G06F 21/00

(52) U.S. Cl. 726/22

(57) ABSTRACT

It is possible to provide an unauthorized operation monitoring program for calculating a modified score by reflecting a suspicious value determined from a series of operations by a user who operates a computer in order to monitor an unauthorized operation on the computer. When a modified score that indicates probability of an unauthorized operation is calculated for an object event, a suspicious value (PSV) corresponding to the level of the calculated modified score is set. When a new event occurs next time, for the score (direct score) calculated for the new event, a modified score reflecting the PSV set for the previous event and a time difference between the previous event and the new event is calculated. When operations that the probability of the unauthorized operation is high are continuously performed, or when operations of which the suspicious value is high are repeated, a higher level of a modified score is calculated.

### TECHNICAL FIELD

The present invention relates to an unauthorized operation monitoring program, an unauthorized operation monitoring method, and an unauthorized operation monitoring system for calculating a modified score based on a suspicion value determined from a series of operations by a user, who operates a computer, in order to monitor an unauthorized operation on the computer.

### BACKGROUND ART

When computers are used in a company or the like, it has been an important problem to prevent data leakage and information leakage from the inside thereof resulting from unauthorized operations of the computers together with preventing unauthorized data entry from the outside through a network, such as the Internet. In order to prevent such information leakage from the inside thereof, the present applicant provides an internal information leakage preventing system for automatically detecting the unauthorized operations on the computers and thereby taking measures (http://www.iwi.co.jp/japanese/CWAT/index.html).

In the above-described internal information leakage preventing system, the probability of respective operations being unauthorized is determined while monitoring unusual actions different from the usual actions on the computer by a user, and when it is determined that the probability of an action being an unauthorized action is high, predetermined actions for preventing information leakage such as stopping output to a printer or writing on an external disk are executed (for example, refer to Patent Document 1 cited below). In the determination of the probability of an action being unauthorized, various determination methods such as detecting unusual actions different from the usual operations with reference to a profile for every user, referring to a profile not only for every user but also node, or the like (for example, refer to Patent Document 2 cited below) can be employed other than comparing with a general rule of the unauthorized action.

Patent Document 1: Japanese Unexamined Patent Publication (Kokai) No. 2005-149243

Patent Document 2: International Publication Pamphlet WO05/048119

### DISCLOSURE OF THE INVENTION

### Problem To Be Solved By the Invention

As described above, in the case of determining a probability of an operation being an unauthorized operation while monitoring operations on a computer, if an operation individually performed corresponds to a case where it is generally an unauthorized action in many cases when compared with a general rule or an action pattern for every user (for example, a case of writing large volumes of data), or a case where it is recognized as an unusual action for the user who has performed the operation (for example, a case of performing an output operation of data on holidays when the user usually do not operate the computer), it is determined that the probability of an operation being the unauthorized operation is high. Namely, the determination of an unauthorized operation is to be individually performed for each operation.

However, even for the same operation in which the probability of an operation being the unauthorized operation is high, it is common that the probabilities of an operation being an unauthorized operation are different depending on a procedure of a series of operations performed previously. For example, even for the same operation of writing a large volume of data, if there are a case where the computer is started during usual working hours and the data is written after document creation or the like is performed, and a case where the computer is started at midnight out of working hours and writing is successively performed from the copy of the large volumes of data, it is considered that the latter action obviously has a higher degree of suspicion when capturing them as a series of operations.

Hence, in order to more accurately and elaborately determine the probability of an operation being the unauthorized operation while monitoring the operations on the computer, it is more preferable to perform the determination by using a suspicion value indicating a degree of suspicion reflecting a flow of a series of continuous operations by the user than to perform the determination by individually capturing a degree of suspicion of the operation performed on the computer.

The present invention addresses such problems, and relates to an unauthorized operation monitoring program, an unauthorized operation monitoring method, and an unauthorized operation monitoring system for calculating a modified score based on a suspicion value determined from a series of operations by the user, who operates the computer, in order to monitor unauthorized operations on the computer.

### Means For Solving the Problem

In the present invention, when a modified score indicating a probability that a user operation is an unauthorized operation is calculated, a suspicion value corresponding to a level of the calculated modified score is set. When a new operation is performed next time, a modified score is calculated with respect to a new score calculated for the operation based on the suspicion value set by the last operation, so that a higher level of the modified score may be calculated, when operations that the probability of the unauthorized operation is high are successively performed, or when operations of which the suspicion value is higher are repeated.

An unauthorized operation monitoring program in accordance with the present invention is an unauthorized operation monitoring program for calculating a modified score indicating a probability of an unauthorized operation in an n-th event generated by a user operation based on a suspicion value determined from a past operation progress of the user, in order to monitor the unauthorized operations by the user to a computer, wherein a suspicion value based on a modified score in an (n−1)th event generated by the user operation is temporarily stored in a memory of the computer. The unauthorized operation monitoring program causes the computer to execute: an event reception step of receiving the n-th event generated by the user operation; a direct score calculating step of referring to at least one of an unauthorized rule storage unit for storing a rule for determining whether or not the event corresponds to the unauthorized operation, and the unit being provided in the computer or another computer connected with the computer through a network, or a profile storage unit for storing a profile on the events generated by the past operations of the user, and the unit being provided in the computer or another computer connected with the computer through a network, and thereby calculating a direct score reflecting a probability that the operation that has generated the n-th event is the unauthorized operation; a time difference calculating step of calculating a time difference between a time of receiving the (n−1)th event and a time of receiving the n-th event; a modified score calculating step of calculating a modified score indicating the probability of the unauthorized operation in the n-th event based on the time difference, and the suspicion value read from a memory area of the computer to the direct score; if the modified score exceeds a predetermined reference value, an unauthorized operation stopping step of executing a command for stopping actions to be executed by the operation that has generated the n-th event; and a suspicion value updating step of updating a suspicion value based on the modified score in the (n−1)th event and temporarily stored in the memory of the computer to a suspicion value based on the modified score in the n-th event, based on the modified score in the n-th event calculated by the modified score calculating step to the suspicion value, and temporarily storing the updated suspicion value in the memory of the computer.

Moreover, the unauthorized operation monitoring program may be characterized in that a multiplication value storage unit for defining and storing a multiplication value corresponding to a level of the modified score is provided in the computer or another computer connected with the computer through a network, wherein, in the suspicion value updating step, a multiplication value corresponding to the modified score in the n-th event calculated by the modified score calculating step is acquired from the multiplication value storage unit, and the suspicion value based on the modified score in the (n−1)th event and temporarily stored in the memory of the computer is multiplied by the multiplication value and thereby updated to the suspicion value based on the modified score in the n-th event.

Further, the unauthorized operation monitoring program may be characterized by causing the computer to execute an initial value storing step in which the suspicion value is set to an initial value and temporarily stored in the memory of the computer when the computer receives a login from the user, wherein, if the event received in the event reception step is a first event generated by the user operation, the direct score calculated by the direct score calculating step is specified as the modified score in the modified score calculating step, and the initial value temporarily stored in the memory of the computer is updated to the suspicion value based on the modified score in the first event specified by the modified score calculating step to the initial value in the suspicion value updating step, and temporarily stored in the memory of the computer.

An unauthorized operation monitoring method in accordance with the present invention is an unauthorized operation monitoring method for calculating a modified score indicating a probability of an unauthorized operation in an n-th event generated by a user operation based on a suspicion value determined from a past operation of the user, in order to monitor the unauthorized operations by the user to a computer, wherein a suspicion value based on a modified score in an (n−1)th event generated by the user operation is temporarily stored in a memory of the computer. The unauthorized operation monitoring method comprises: an event reception step in which the computer receives the n-th event generated by the user operation; a direct score calculating step in which the computer refers to at least one of an unauthorized rule storage unit for storing a rule for determining whether or not the event corresponds to the unauthorized operation, and the unit being provided in the computer or another computer connected with the computer through a network, or a profile storage unit for storing a profile on the events generated by the past operations of the user, and the unit being provided in the computer or another computer connected with the computer through a network, and thereby calculates a direct score based on a probability that the operation that has generated the n-th event is the unauthorized operation; a time difference calculating step in which the computer calculates a time difference between a time of receiving the (n−1)th event and a time of receiving the n-th event; a modified score calculating step in which the computer calculates a modified score indicating the probability of the unauthorized operation in the n-th event based on the time difference, and the suspicion value read from a memory area of the computer to the direct score; if the modified score exceeds a predetermined reference value, an unauthorized operation stopping step in which the computer executes a command for stopping actions to be executed by the operation that has generated the n-th event; and a suspicion value updating step in which the computer updates a suspicion value based on the modified score in the (n−1)th event and temporarily stored in the memory of the computer to a suspicion value based on the modified score in the n-th event, based on the modified score in the n-th event calculated by the modified score calculating step to the suspicion value, and temporarily stores the updated suspicion value in the memory of the computer.

Moreover, the unauthorized operation monitoring method may be characterized in that a multiplication value storage unit for defining and storing a multiplication value corresponding to a level of the modified score is provided in the computer or another computer connected with the computer through the network, wherein, in the suspicion value updating step, a multiplication value corresponding to the modified score in the n-th event calculated by the modified score calculating step is acquired from the multiplication value storage unit, and the suspicion value based on the modified score in the (n−1)th event and temporarily stored in the memory of the computer is multiplied by the multiplication value and thereby updated to the suspicion value based on the modified score in the n-th event.

Further, the unauthorized operation monitoring method may be characterized by comprising an initial value storing step in which, by the computer, the suspicion value is set to an initial value and temporarily stored in the memory of the computer when the computer receives a login from the user, wherein, if the event received in the event reception step is a first event generated by the user operation, the direct score calculated by the direct score calculating step is specified as the modified score in the modified score calculating step, and the initial value temporarily stored in the memory of the computer is updated to the suspicion value based on the modified score in the first event specified by the modified score calculating step to the initial value in the suspicion value updating step, and temporarily stored in the memory of the computer.

An unauthorized operation monitoring system in accordance with the present invention is an unauthorized operation monitoring system for calculating a modified score indicating probability of an unauthorized operation in an n-th event generated by a user operation based on a suspicion value determined from a past operation progress of the user, in order to monitor the unauthorized operations by the user to a computer. The unauthorized operation monitoring system comprises: a suspicion value storage means for temporarily storing the suspicion value based on the modified score in the event generated by the user operation; an event receiving means for receiving the n-th event generated by the user operation; an unauthorized rule storage means for storing a rule for determining whether or not the event received by the event receiving means corresponds to the unauthorized operation; a profile storage means for storing a profile on the events generated by the past operations of the user; a direct score calculating means for referring to at least one of the unauthorized rule storage means or the profile storage means, and thereby calculating a direct score based on the probability that the operation that has generated the n-th event is the unauthorized operation; a time difference calculating means for calculating a time difference between a time of receiving the (n−1)th event and a time of receiving the n-th event; a modified score calculating means for calculating a modified score indicating the probability of the unauthorized operation in the n-th event based on the time difference, and a suspicion value based on the modified score in the (n−1)th event and read from the suspicion value storage means to the direct score; if the modified score exceeds a predetermined reference value, an unauthorized operation stopping means for executing a command for stopping actions to be executed by the operation that has generated the n-th event; and a suspicion value updating means for updating the suspicion value based on the modified score in the (n−1)th event and stored in the suspicion value storage means to the suspicion value based on the modified score in the n-th event, based on the modified score calculated by the modified score calculating means to the suspicion value.

Moreover, the unauthorized operation monitoring system may be characterized by comprising a multiplication value storage means for defining and storing the multiplication value corresponding to the level of the modified score calculated by the modified score calculating means, wherein, by the suspicion value updating means, the multiplication value corresponding to the modified score in the n-th event calculated by the modified score calculating means is acquired from the multiplication value storage means, and the suspicion value based on the modified score in the (n−1)th event and temporarily stored in the suspicion value storage means is multipled by the multiplication value and thereby updated to the suspicion value based on the modified score in the n-th event.

Further, the unauthorized operation monitoring system may be characterized by comprising a suspicion value initialization means for setting the suspicion value to be stored in the suspicion value storage means to an initial value when the computer receives a login from the user, wherein, if the event received by the event receiving means is the first event generated by the user operation, the direct score calculated by the direct score calculating means is specified as the modified score by the modified score calculating means, and when the suspicion value based on the modified score in the first event is updated by the suspicion value updating means, the initial value stored in the suspicion value storage means is updated to the suspicion value based on the modified score specified by the modified score calculating means to the initial value.

### Effect of the Invention

According to the present invention, when the unauthorized computer operations are monitored, the modified score is calculated based on not only the suspicion degree of the individual operation on the computer but also the suspicion degree determined from a series of operations by the user, thereby allowing the score value based on the suspicion degree to be calculated more accurately and elaborately. The probability of the unauthorized operation is determined based on the score value, which is calculated more accurately and elaborately, to thereby cope with it, thus allowing security against an internal information leakage or the like to be enhanced.

### BEST MODE(S) FOR CARRYING OUT THE INVENTION

Hereinafter, best modes for carrying out the present invention will be described in detail using the drawings. It is to be understood that specific examples such as formulas of calculating modified scores, setting of multiplication values, or the like illustrated in the embodiments described hereinafter are one example of the present invention, and the present invention is not limited to such embodiments.

FIG. 1 is a view showing a mode of use of an unauthorized operation monitoring system in accordance with the present invention. FIG. 2 is a block diagram showing a configuration of the unauthorized operation monitoring system in accordance with the present invention. FIG. 3 is a view showing a method for calculating a modified score by the unauthorized operation monitoring system in accordance with the present invention. FIG. 4 is a view showing one example of a PSV arithmetic table in the unauthorized operation monitoring system in accordance with the present invention. FIG. 5 is a view showing an example of a change in a value by which a direct score is multiplied according to a time difference in the unauthorized operation monitoring system in accordance with the present invention. FIG. 6 through FIG. 14 are first through ninth views, respectively, showing actions for monitoring the modified score in the unauthorized operation monitoring system in accordance with the present invention. FIG. 15 and FIG. 16 are first and second flow charts, respectively, showing a flow for monitoring the modified score in the unauthorized operation monitoring system in accordance with the present invention.

The mode of use of the unauthorized operation monitoring system in accordance with the present invention will be described using FIG. 1. Since the unauthorized operation monitoring system in accordance with the present invention is introduced mainly as measures against internal information leakage in a company or the like, it is usually used in a computer connected to an intra-company LAN or the like, but it may be used in a stand-alone computer. While FIG. 1 shows an example used for operation monitoring at a user terminal which is connected to a network, such as the intra-company LAN or the like, and which is used by general staffs or the like in the company, the user terminal is provided with a program for monitoring, which performs processing of stopping actions executed by an operation determined to have a high unauthorized probability at respective terminals.

In addition, the unauthorized operation monitoring system in accordance with the present invention can also be applied to a case of monitoring data flowing through the network in a segment unit or by the whole network in a monitoring server, monitoring mails transmitted and received from a mail server, monitoring data via a gateway, or the like, other than the operations on the user terminal. These monitoring cases, although an object to be monitored is not limited to the operations executed on the computer, but data acquired from the network and data written in the server will also be monitored, are not different from a case of calculating the modified score for the operations in that a rule or the like is applied to these data to calculate a modified score, so that it is possible to similarly apply a computing type of the modified score according to the present invention thereto.

Incidentally, although the general rule for calculating the modified score and the profile for every user for determining an unusual action are usually stored in each of computers provided with a monitoring program, it may also be configured such that, while storing the program in the unauthorization monitoring server or the like within a network, the rule and the profile are referred to by accessing the unauthorization monitoring server during the calculation of the modified score.

In FIG. 2, the unauthorized operation monitoring system in accordance with the present invention is provided with a computer 10 connected to a LAN. In order to execute predetermined processing based on application programs stored in a HDD 14 in the computer 10, various fundamental programs for hardware control, such as input control, output control, or the like stored in a ROM 13 are started, and a CPU 11 performs arithmetic processing while operating a RAM 12 as a work area of the application programs.

An unauthorization determination program 141 for determining whether or not the operation received by the computer 10 is unauthorized, and a PSV arithmetic program 142 for calculating a suspicion value indicating a degree of suspicion of a series of operations (it is referred to as “PSV” from the abbreviation for Previous Status Value in the following description), wherein the suspicion value is used for a part of unauthorized determination, are stored in the HDD 14. A PSV arithmetic table 143, which is referred to in calculating the PSV used for the next determination from the modified score calculated by the unauthorization determination program 141, is also stored therein.

The RAM 12 is provided with a PSV storage unit 121, which is an area for storing the PSV, and the PSV calculated by the PSV arithmetic program 142 is temporarily stored in the PSV storage unit 121. The temporarily stored PSV is read therefrom during the next modified score calculation, and when the next modified score is calculated, it is updated to a new PSV based on the modified score to be then temporarily stored in the PSV storage unit 121. Incidentally, the PSV storage unit 121 may be provided in a virtual memory area of the HDD 14.

Further, the HDD 14 is provided with an operation log storage unit 144 for storing information on contents, reception time, or the like, of the operation received by the computer 10. In order to calculate the modified score by the unauthorization determination program 141, a user profile storage unit 145 for defining an action pattern for every user, which is used as a basis for score calculation, and an unauthorization determination rule storage unit 146 for regularizing common patterns on the unauthorized operation, and the like are provided, but a part or all of these may be provided in the unauthorization monitoring server 50 to thereby be referred to via the LAN for every calculation of the modified score. In addition, when the HDD 14 of the computer 10 is provided with the unauthorization determination rule storage unit 146, a new set rule may be transmitted from the unauthorization monitoring server 50 to update the rules stored in the unauthorization determination rule storage unit 146 as required.

When the unauthorization determination program 141 determines that the probability that a received operation is unauthorized is high, the unauthorization determination program 141 executes actions for stopping the operation. For example, when an operation for transmitting data outside through the LAN is determined to be unauthorized, a command is sent to a NIC 15 for stopping the data transmission, while when an operation for performing a data output or writing to an output device 30 or an external storage device 40 is determined to be unauthorized, a command is sent for stopping an output instruction or a write instruction transmitted to an external connection bus 16.

Here, a method for calculating the modified score based on a degree of suspicion of a series of operations using the PSV will be described using FIG. 3. When the computer receives an event generated by an operation performed by the user, the event being a calculation object for the modified score, a user profile in which rules for unauthorized determination and usual action patterns of the user are recorded is referred to in order to calculate a direct score (hereinafter, referred to as Direct Score[=]“DS”) that indicates the probability of an operation being unauthorized in a manner similar to that of the conventional unauthorized determination system. In the conventional unauthorized determination system, the direct score calculated here is employed as the modified score as it is.

Compared with this, in order to reflect a degree of suspicion of an operation progress up to a previous event to the score with respect to the direct score, a modified score (hereinafter, referred to as Modified Score[=]“MS”) which is adjusted using a predetermined numerical value is calculated in the present invention. Specifically, the PSV which reflects a numerical value relevant to a time difference from a previous event to an object event (hereinafter, referred to as “Term %”) and the degree of suspicion up to the previous event is used for adjustment of the modified score.

As for the time difference from the previous event to the object event, it is generally considered that the shorter the time difference is, the higher the degree of suspicion is. Accordingly, for example, the time difference is to be calculated by Term %=1.00−{(object event occurrence time−previous event occurrence time)/100} (unit of generating time is a minute).

As for the PSV, it is preferable that a higher modified score may be calculated as operations with high unauthorized probability are performed successively even in the same operation. The reason is that for example, even in the same operation of writing a large amount of files with high unauthorized probability, when a case where the operation is executed after general operations, such as document file creation, during a usual working hours, and a case where the same operation is executed after a computer is started at night out of working hours and files which are hardly accessed usually are accessed are compared with each other, it is considered that the latter case clearly indicates a high probability of an operation being unauthorized.

Accordingly, in setting the PSV, the PSV set by the previous event is multiplied by a corresponding multiplication value, which depends on the level of the modified score calculated due to the object event, using, for example, a PSV arithmetic table shown as an example in FIG. 4, so that it becomes possible to set a PSV value high, as the operation with high unauthorized probability is successively performed. Note that, the PSV is set to the initial value (=1.00) when a user to be a target logs on to the computer, and shall be updated as required until the user logs off.

Namely, the PSV is set as PSV=1.00 upon login, and when the multiplication value is specified as 1.30 from the modified score of the first event, the PSV is updated as PSV=1.00×1.30=1.30. Further, when the multiplication value is specified as 1.30 also from the modified score of the next event, PSV=1.30×1.30=1.69 is obtained, and when the high modified score is successively calculated, the PSV value will also increase sequentially.

As described until now, when the PSV and the Term % shall be calculated, the modified score (MS) can be defined by calculating, for example,

MS=DS×{(PSV−1.00)×Term %+1.00}.

According to such a formula, as the operations further continue for a short time (as the value of [=]Term % is larger), and as the operations with high unauthorized probability further continues (as the [=]PSV is higher), it is possible to calculate the modified score (MS) based on the actual condition more accurately and elaborately from the direct score (DS) calculated only from the object event.

As described above, although the modified score (MS) is calculated by multiplying the direct score (DS) by (PSV−1.00)×Term %+1.00, when the time difference between the object event occurrence time and the previous event occurrence time is 100 minutes, the following result is obtained:

Term %=0,

and thus the value by which the direct score (DS) is multiplied will be 0. This relationship is shown in FIG. 5, wherein a dotted line indicates behavior of the changes of the multiplying value according to the time difference in the case of PSV=1.30, while a dashed line indicates behavior of the change of the multiplying value according to the time difference in the case of PSV=0.90. Namely, even when suspicious actions continue to thereby increase the PSV, it is determined that relevance with the previous event is low as the time difference between this event and the previous events is increased, and thus the multiplying value will be converged to 1.00. Similarly in a case where normal actions continue to thereby decreases the PSV, it is determined that relevance with the previous event is low as the time difference between this event and the previous events is increased, and thus the multiplying value will be converged to 1.00.

Subsequently, the actions for monitoring the modified score in the unauthorized operation monitoring system in accordance with the present invention will be described using FIG. 6 through FIG. 14. Note herein that a main memory shown in FIG. 6 through FIG. 14 shall also include a virtual memory on a hard disk other than a main memory provided in the computer.

First, when the user logs on to the computer as shown in FIG. 6, the initial value 1.00 of the PSV is temporarily stored in a predetermined storage area (the PSV storage unit 121 in the case of FIG. 2) of the main memory.

As shown in FIG. 7, when the user who has logged in performs the first operation, the unauthorization determination program (the unauthorization determination program 141 in the case of FIG. 2) is read from the hard disk to the main memory in order to receive an event 1 generated by the operation to determine whether or not the event 1 is due to an unauthorized operation. Although a direct score that indicates a probability that the event 1 is unauthorized is calculated by the read unauthorization determination program, a scoring model for calculating the direct score is not limited in particular.

For example, the event 1 may be compared with the user profile which defines the usual action pattern of the user to thereby determine the probability of event 1 being unauthorized for the user depending on whether or not it corresponds to the unusual action, or alternatively, the event 1 may be compared with the unauthorization determination rule which defines the common unauthorized pattern to thereby determine the probability of event 1 being unauthorized depending on whether or not it corresponds to a pattern which is unauthorized in many cases based on rules of thumb.

Further, information on the received event 1 is recorded on a predetermined storage area (the operation log storage unit 144 in the case of FIG. 2) of the hard disk as a log, as shown in FIG. 8. The information to be recorded may include a time (it may be a received time) when the event 1 occurred.

When a modified score of the first event is calculated, the previous event does not exist after the login, and thus a time difference between the first event and the previous event can not be calculated. Meanwhile, the PSV is set to 1.00, which is the initial value. Hence, as for a first modified score, the direct score previously calculated is employed as it is, as shown in FIG. 8.

When the modified score on the event 1 is calculated in this way, it is determined whether or not the operation for generating the event 1 is unauthorized depending on whether or not the modified score exceeds a predetermined threshold value. When the score exceeds the threshold value, a command for stopping the operation which generated the event 1, for example, processing of stopping output to the printer or writing to the external disk, processing of disconnecting connections with a network, processing of stopping E-mail transmissions, or the like is executed as shown in FIG. 9. When it does not exceed the threshold value, the processing by the event 1 will be executed as it is.

When the unauthorized determination on the event 1 is completed, the PSV arithmetic program (the PSV arithmetic program 142 in the case of FIG. 2) is read from the hard disk to the main memory in order to update the PSV based on the calculated modified score as shown in FIG. 10. A new PSV based on the calculated modified score on the event 1 is calculated by the read PSV arithmetic program, and the PSV value temporarily stored in the main memory is updated.

The new PSV is calculated by referring to the PSV arithmetic table (the PSV arithmetic table 143 in the case of FIG. 2) stored in the hard disk, acquiring a multiplication value corresponding to the calculated modified score on the event 1, and multiplying 1.00 stored as the initial value of the PSV by the acquired multiplication value. The initial value of the PSV temporarily stored in the predetermined storage area of the main memory is updated to the calculated new PSV (“1.XX” in FIG. 10).

Next, when the same user performs a second operation, the unauthorization determination program is read from the hard disk to the main memory in order to receive an event 2 generated by this operation to determine whether or not the event 2 is due to the unauthorized operation as shown in FIG. 11. A direct score that indicates a probability that the event 2 is unauthorized is calculated by the read unauthorization determination program.

Additionally, information on the received event 2 is recorded on the predetermined storage area of the hard disk as a log, as shown in FIG. 12. The information to be recorded may include a time (it may be a received time) when the event 2 occurred. Further, the time when the event 1 which is the previous event occurred is acquired from the recorded log to thereby calculate a time difference between it and the time when the event 2 occurred.

When the modified score on the event 2 is calculated, the calculated time difference, and the PSV temporarily stored in the main memory are used. Although there is no particular limitation as to how the time difference and the PSV are used in a formula for the calculation of the modified score, it is preferable to use them to further reduce influences by the PSV as the time difference becomes longer so that the value of the high modified score may be higher as the PSV has a higher value. The modified score on the event 2 is calculated by applying such a formula to the direct score as shown in FIG. 12.

When the modified score on the event 2 is calculated in this way, it is determined whether or not the operation which generated the event 2 is unauthorized depending on whether or not the modified score exceeds the predetermined threshold value. When the score exceeds the threshold value, a command for stopping the operation which generated the event 2 is executed as shown in FIG. 13. When it does not exceed the threshold value, the processing by the event 2 will be executed as it is.

When the unauthorized determination on the event 2 is completed, the PSV arithmetic program is read from the hard disk to the main memory in order to update the PSV based on the calculated modified score as shown in FIG. 14. A new PSV based on the calculated modified score for the event 2 is calculated by the read PSV arithmetic program, and the PSV value stored in the main memory is updated.

The new PSV is calculated by referring to the PSV arithmetic table stored in the hard disk, acquiring a multiplication value corresponding to the calculated modified score on the event 2, and multiplying temporarily stored PSV=1.XX as the value based on the modified score of the event 1 which is the previous event by the acquired multiplication value. PSV=1.XX temporarily stored in the predetermined storage area of the main memory is updated to the calculated new PSV (“1.ΔΔ” as shown in FIG. 14).

Further, when the same user subsequently performs a third or more operations successively, processing similar to that described in FIG. 11 through FIG. 14 will be repeated for every operation of each time. Updating of the PSV is continued from login to logoff by the same user, and the updated PSV is held in the main memory.

Incidentally, the example to determine whether or not the operation that the user executes on the computer is unauthorized has been described in FIG. 6 through FIG. 14, but regarding the calculation method of the modified score using the PSV and the time difference described here, the monitoring of the unauthorized operations is not limited to the case of directly monitoring the operations executed on the computer, but it is also possible to determine unauthorized use of a computer by calculating the modified score in a case of, for example, monitoring transmission and reception of the unauthorized data or the like by the data flowing through a network, such as a LAN or the like, or monitoring transmission and reception of the unauthorized data or the like by the data passing through the gateway. In this case, the data that the monitoring server acquired from the network, or the data passing through the gateway becomes an object for calculating the direct score, instead of the event to be received.

A flow for monitoring the modified score in the unauthorized operation monitoring system in accordance with the present invention will be described using FIG. 15 and FIG. 16. First, when the computer receives an event considered to be an object (S01), it refers to the unauthorization determination rule or the user profile (S02, S03), and calculates a direct score based on only contents of the object event (S04).

When the object event is not the first event (S05), the occurrence time of the event received last time is read from the log (S06), and a time difference between that occurrence time and the occurrence time of the object event received this time is calculated (S07). When the object event is the first event, processing at Step 06 and Step 07 will not be executed.

Next, the temporarily stored PSV is read (S08), and the time difference and the PSV are applied to the direct score to thereby calculate a modified score based on the suspicion degree determined from a series of operations by the user (S09). It is confirmed whether or not the calculated modified score exceeds a reference value for determining it to be unauthorized (S10), and when it exceeds the reference value, processing for stopping processing by the operation which generated the object event is executed (S11). When it does not exceed the reference value, the processing by the operations is executed as it is since the processing is not stopped. The unauthorized determination on the object event is completed according to the above flow shown in FIG. 15.

When the unauthorized determination on the object event is completed in this way, processing of updating the PSV shown in the flow of FIG. 16 is performed. When the processing of the unauthorized determination is completed, the PSV arithmetic table is referred to (S12) to specify a multiplication value corresponding to the calculated modified score on the object event (S13). A new PSV is calculated by multiplying the temporarily stored PSV by the specified multiplication value (S14), the new PSV is stored by updating the temporarily stored PSV to the calculated PSV (S15), and the processing of the PSV update will be completed.

Note that the processing sequence of the processing of executing the operation stop depending on whether or not the modified score exceeds the reference value (S10 and S11) and the processing of the PSV update (S12 through S15) shown in FIG. 15 and FIG. 16 is not limited in particular, but in contrast to the aforementioned description, comparison between the modified score and the reference value may be performed after the PSV update.

### BRIEF DESCRIPTION OF THE DRAWINGS

FIG. 1 is a view showing a mode of use of an unauthorized operation monitoring system in accordance with the present invention;

FIG. 2 is a block diagram showing a configuration of the unauthorized operation monitoring system in accordance with the present invention;

FIG. 3 is a view showing a method of calculating a modified score by the unauthorized operation monitoring system in accordance with the present invention;

FIG. 4 is a view showing one example of a PSV arithmetic table in the unauthorized operation monitoring system in accordance with the present invention;

FIG. 5 is a view showing an example of a change in a value by which a direct score is multiplied according to a time difference in the unauthorized operation monitoring system in accordance with the present invention;

FIG. 6 is a first view showing actions for monitoring a modified score in the unauthorized operation monitoring system in accordance with the present invention;

FIG. 7 is a second view showing actions for monitoring the modified score in the unauthorized operation monitoring system in accordance with the present invention;

FIG. 8 is a third view showing actions for monitoring the modified score in the unauthorized operation monitoring system in accordance with the present invention;

FIG. 9 is a fourth view showing actions for monitoring the modified score in the unauthorized operation monitoring system in accordance with the present invention;

FIG. 10 is a fifth view showing actions for monitoring the modified score in the unauthorized operation monitoring system in accordance with the present invention;

FIG. 11 is a sixth view showing actions for monitoring the modified score in the unauthorized operation monitoring system in accordance with the present invention;

FIG. 12 is a seventh view showing actions for monitoring the modified score in the unauthorized operation monitoring system in accordance with the present invention;

FIG. 13 is an eighth view showing actions for monitoring the modified score in the unauthorized operation monitoring system in accordance with the present invention;

FIG. 14 is a ninth view showing actions for monitoring the modified score in the unauthorized operation monitoring system in accordance with the present invention;

FIG. 15 is a first flow chart showing a flow for monitoring the modified score in the unauthorized operation monitoring system in accordance with the present invention; and

FIG. 16 is a second flow chart showing a flow for monitoring the modified score in the unauthorized operation monitoring system in accordance with the present invention.

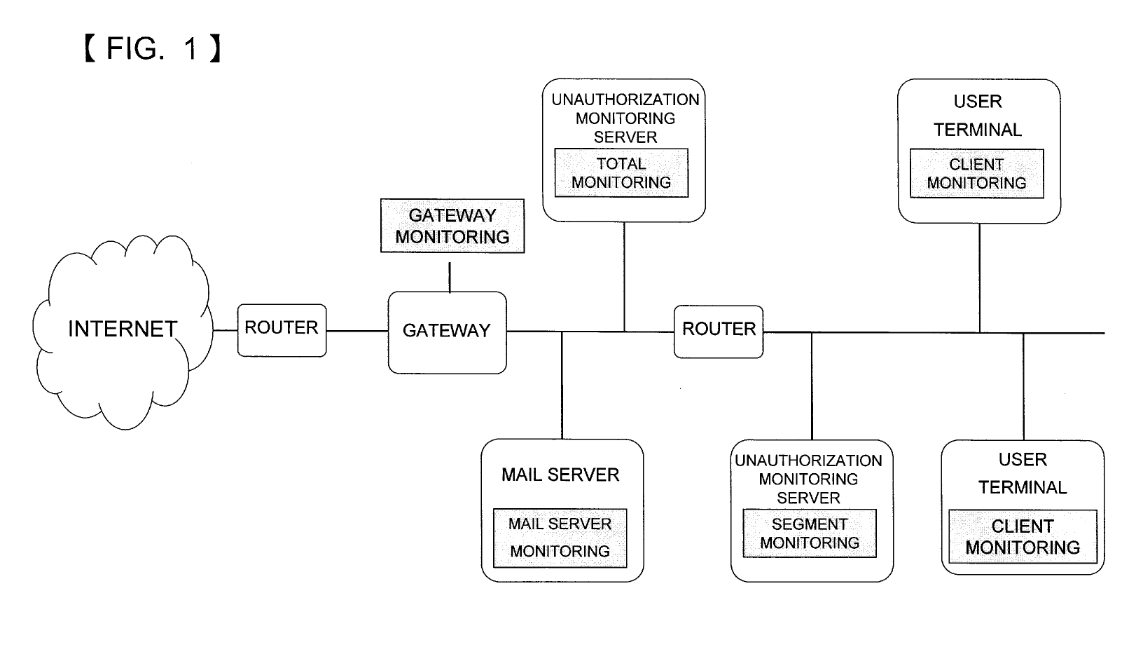

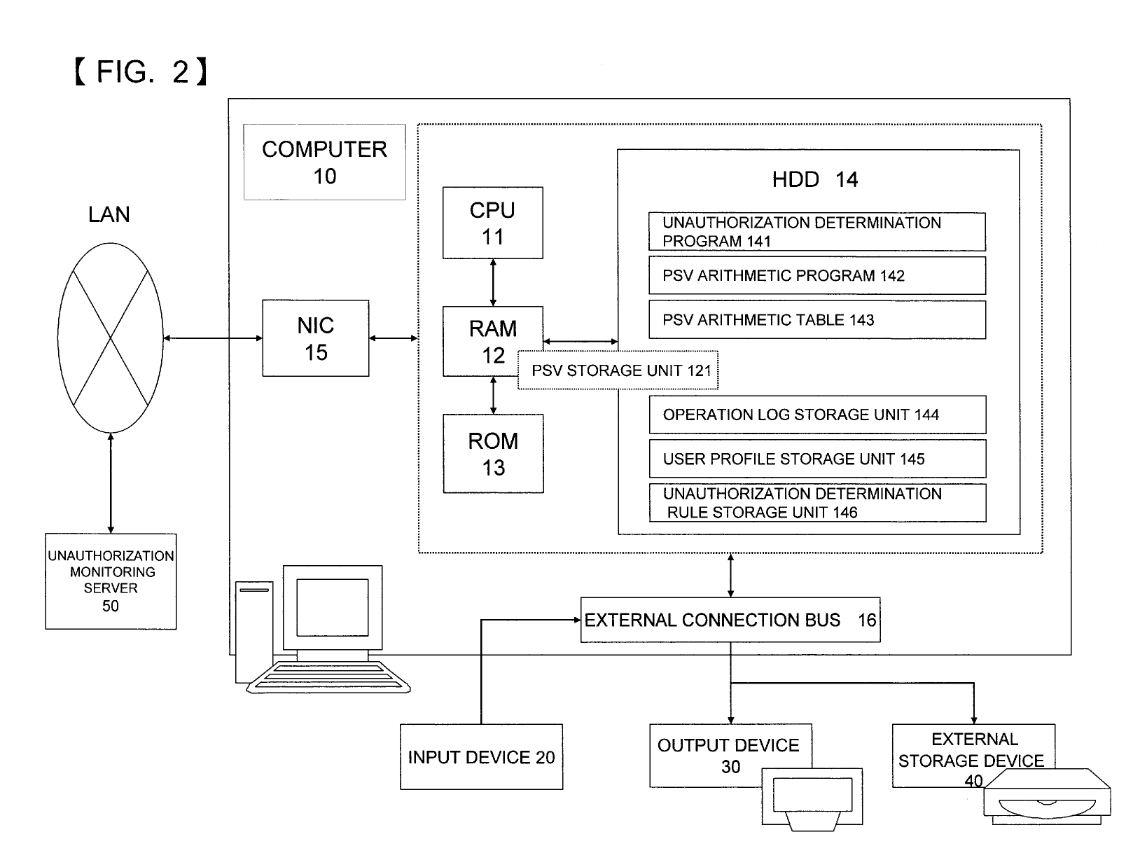

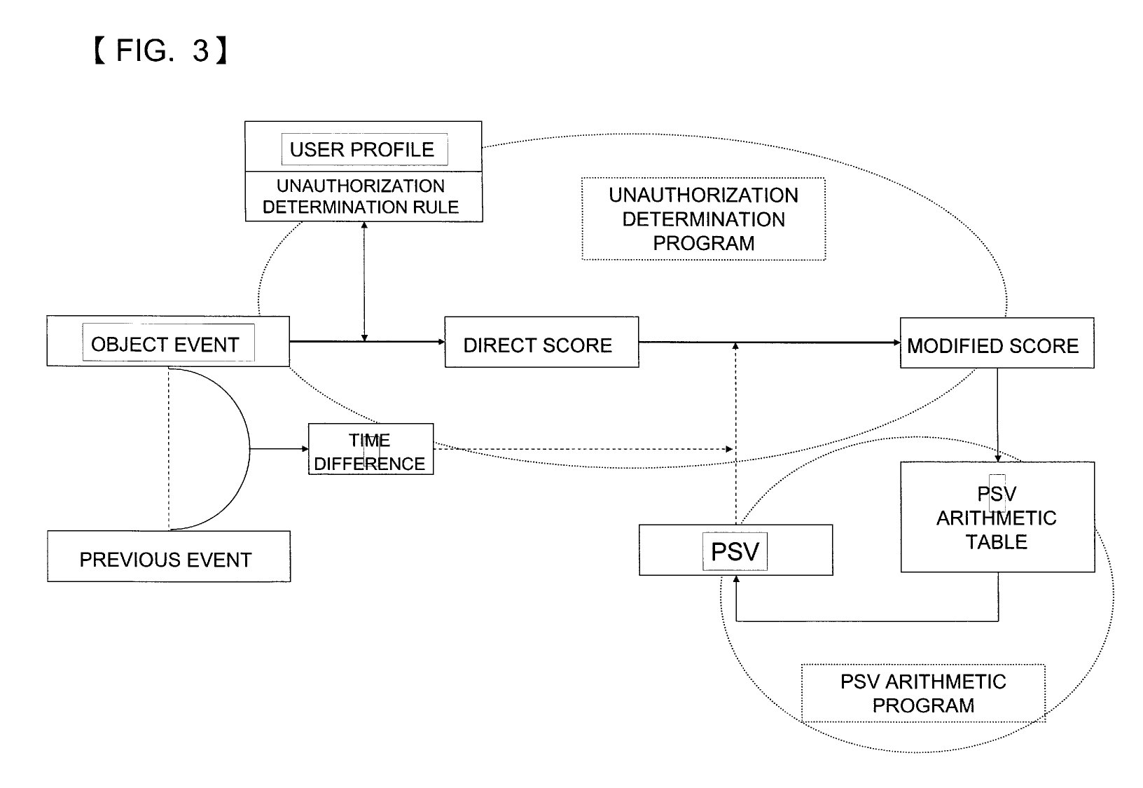

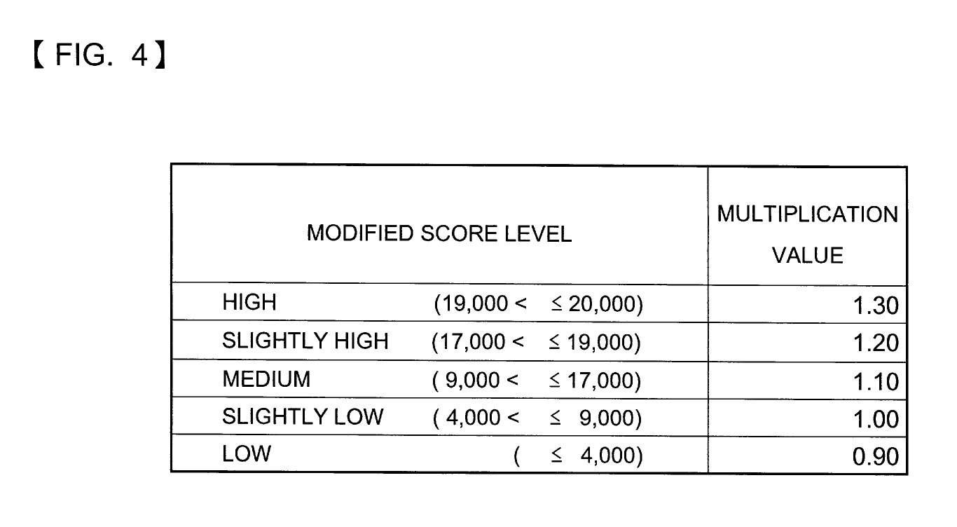

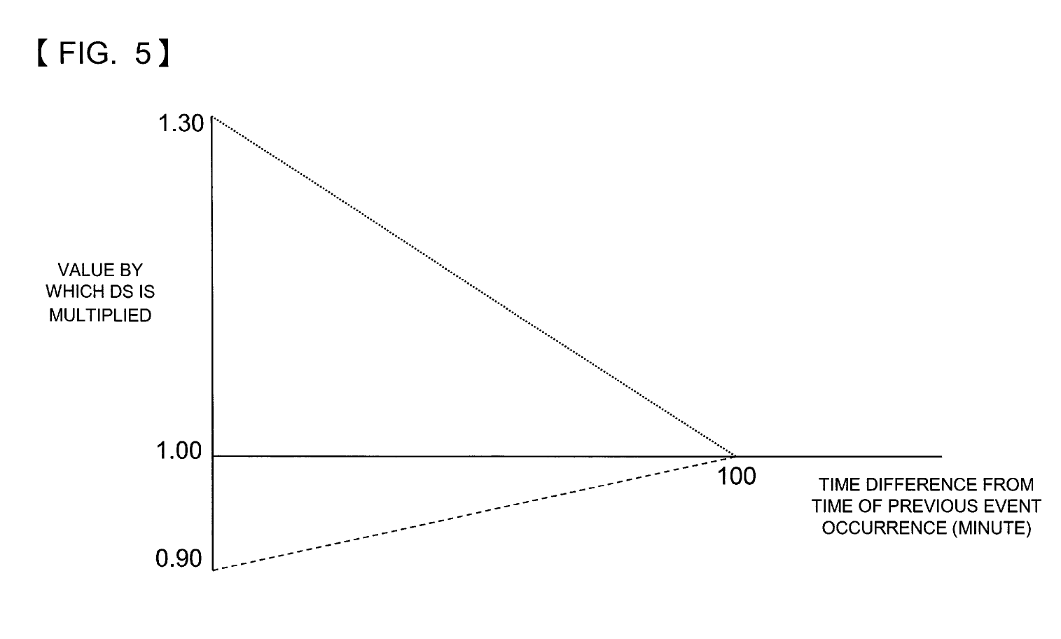

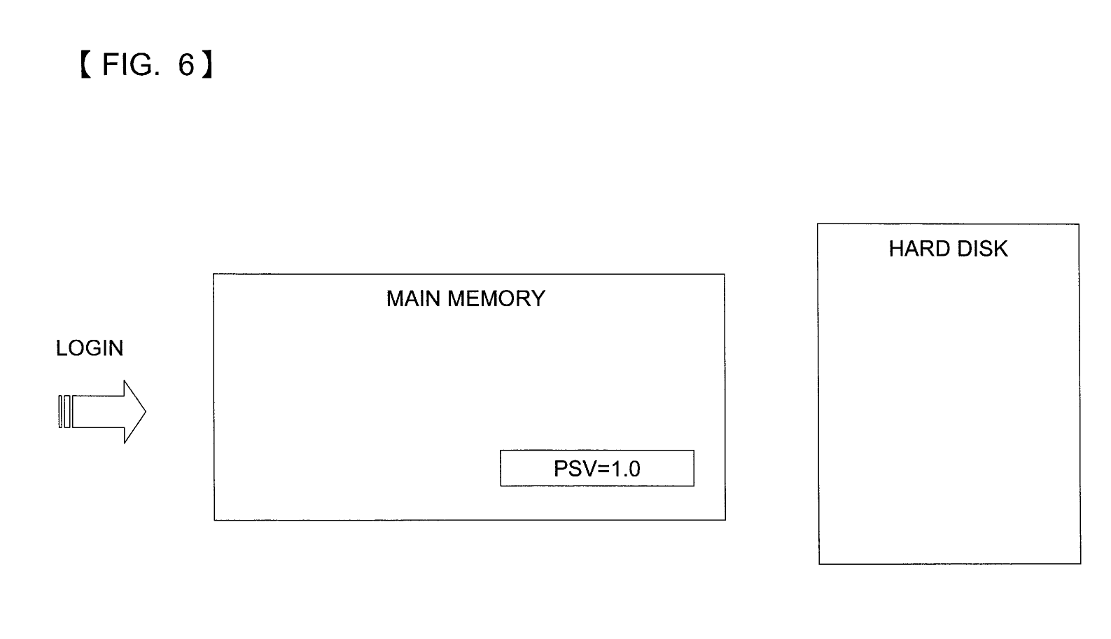

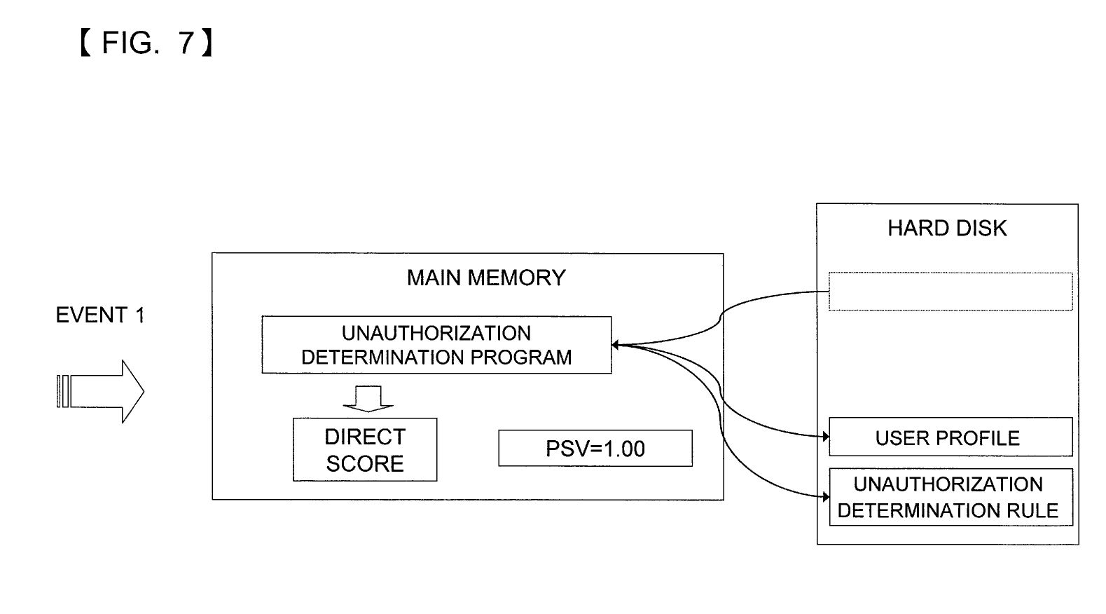

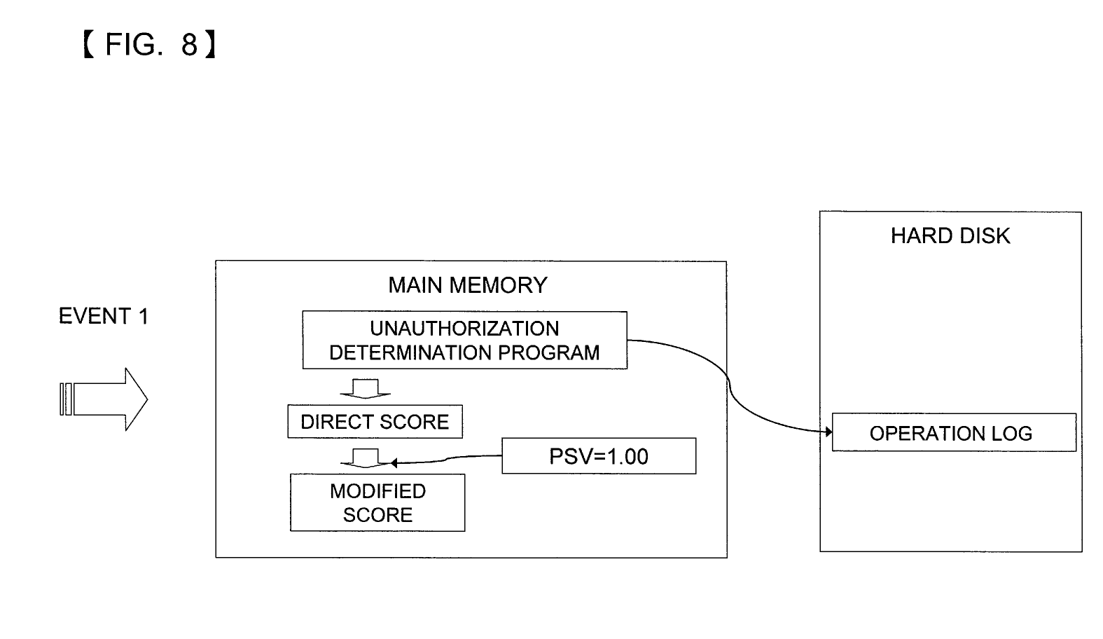

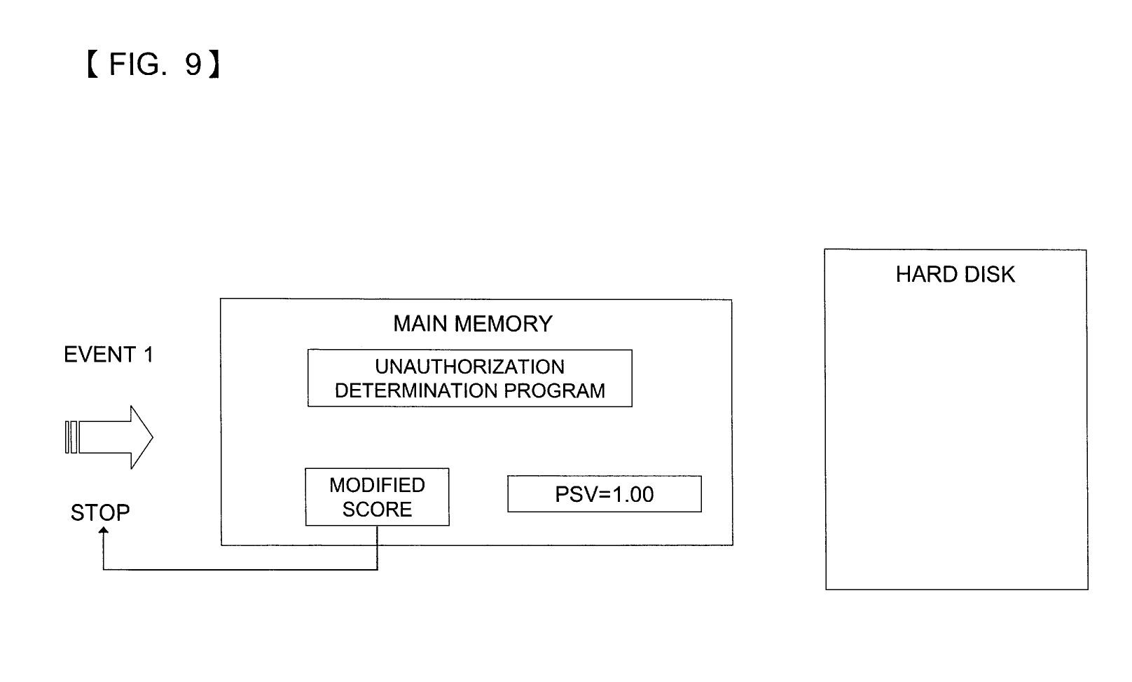

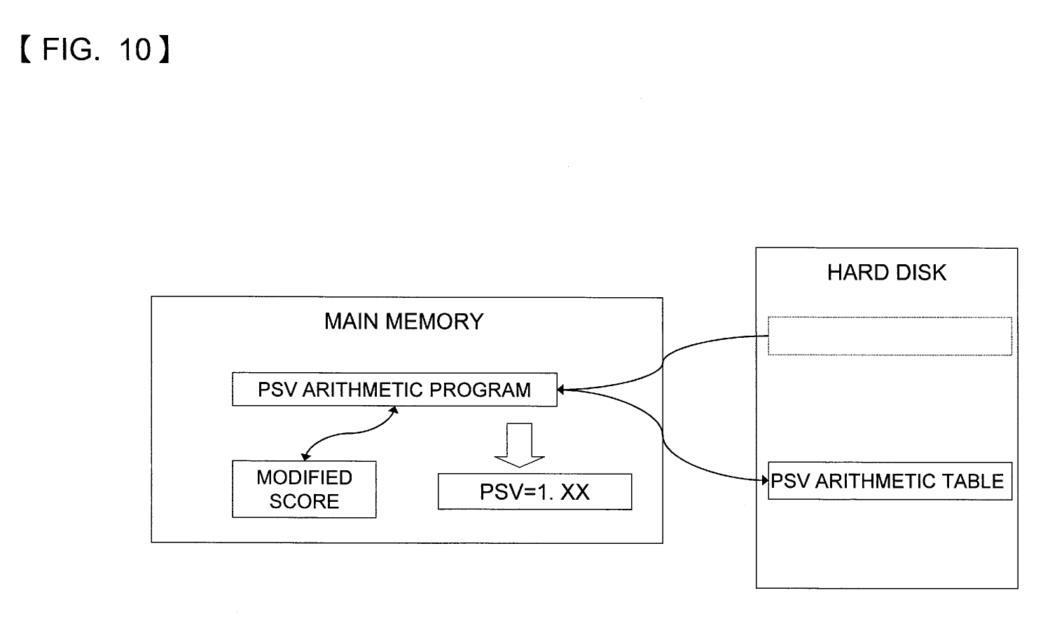

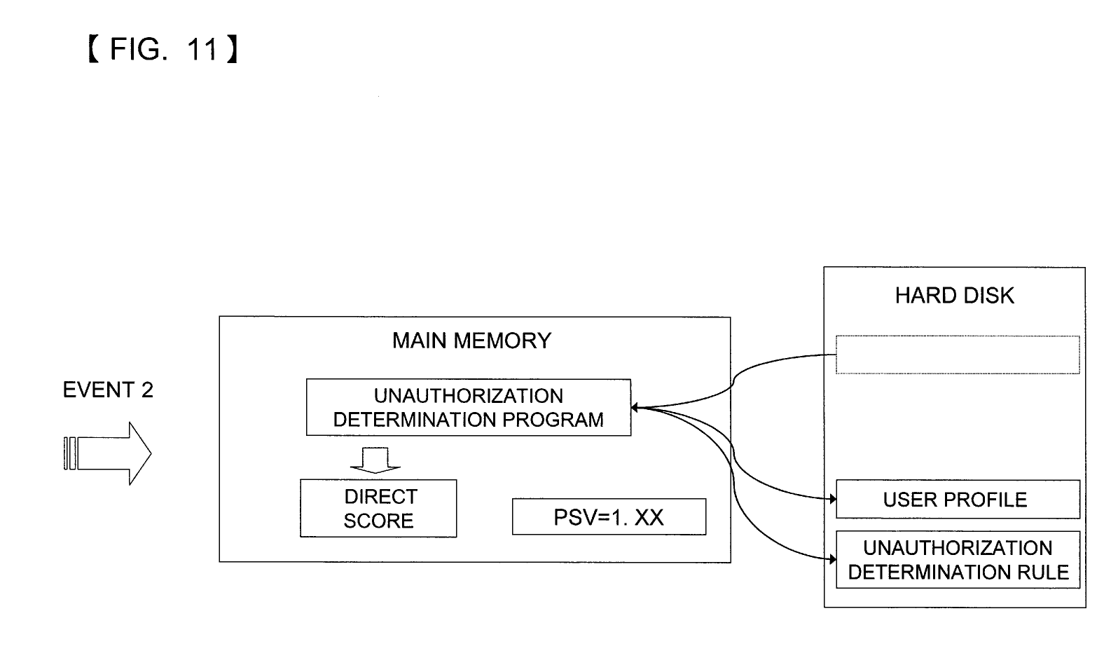

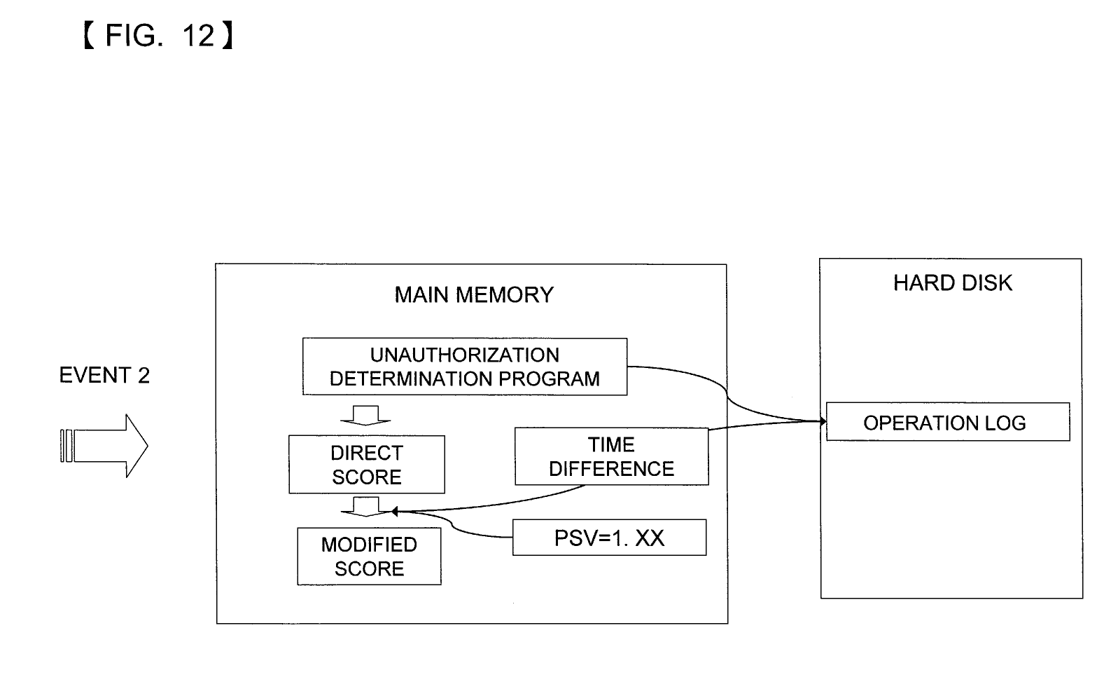

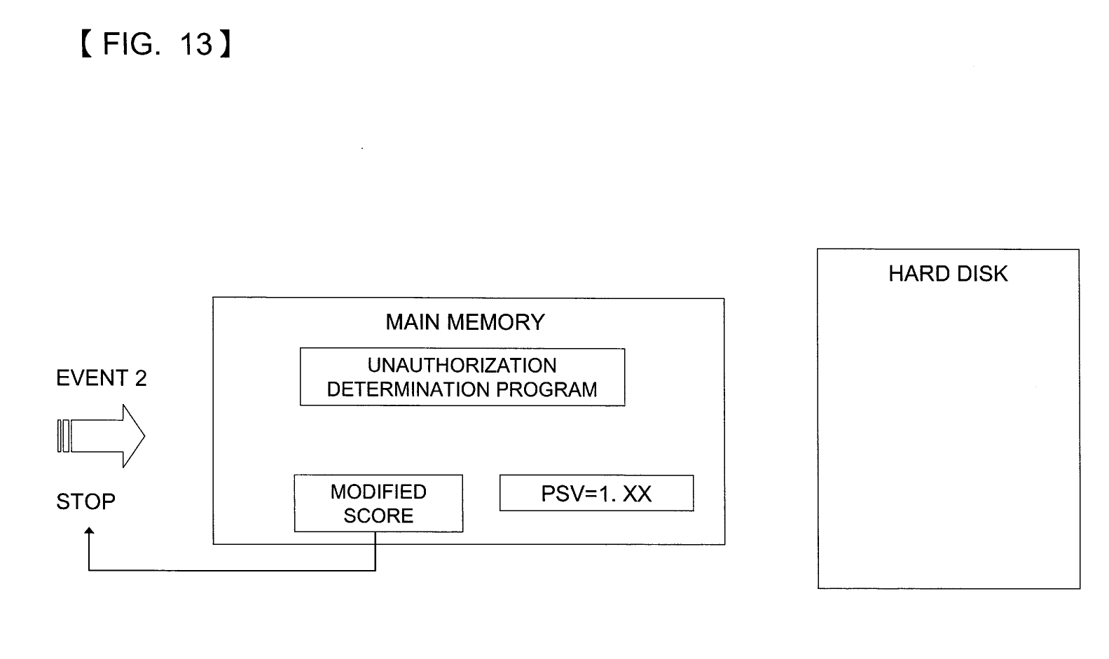

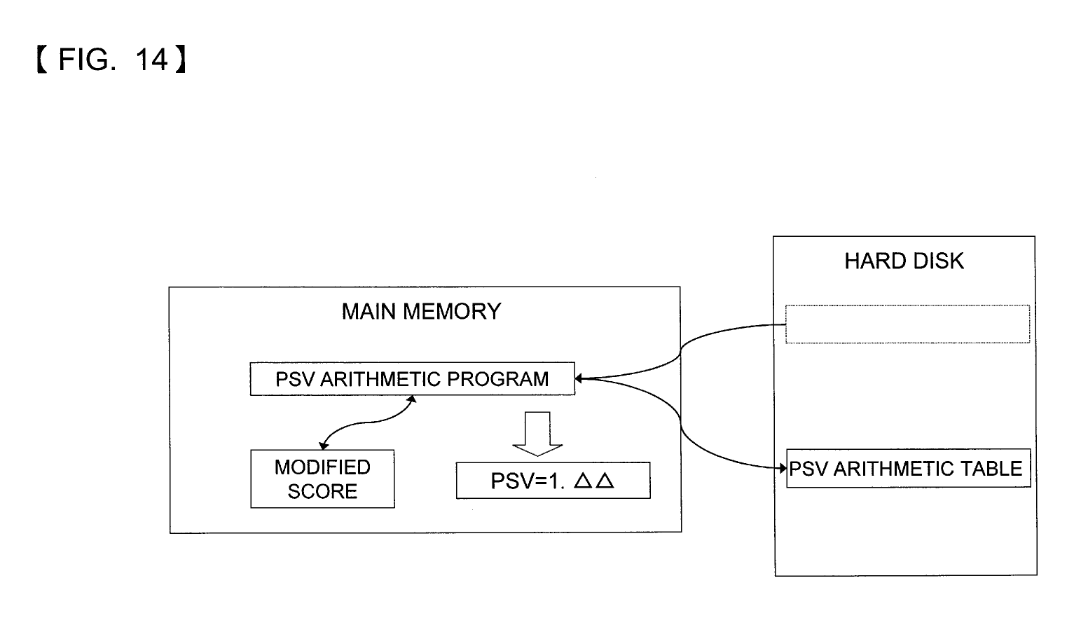

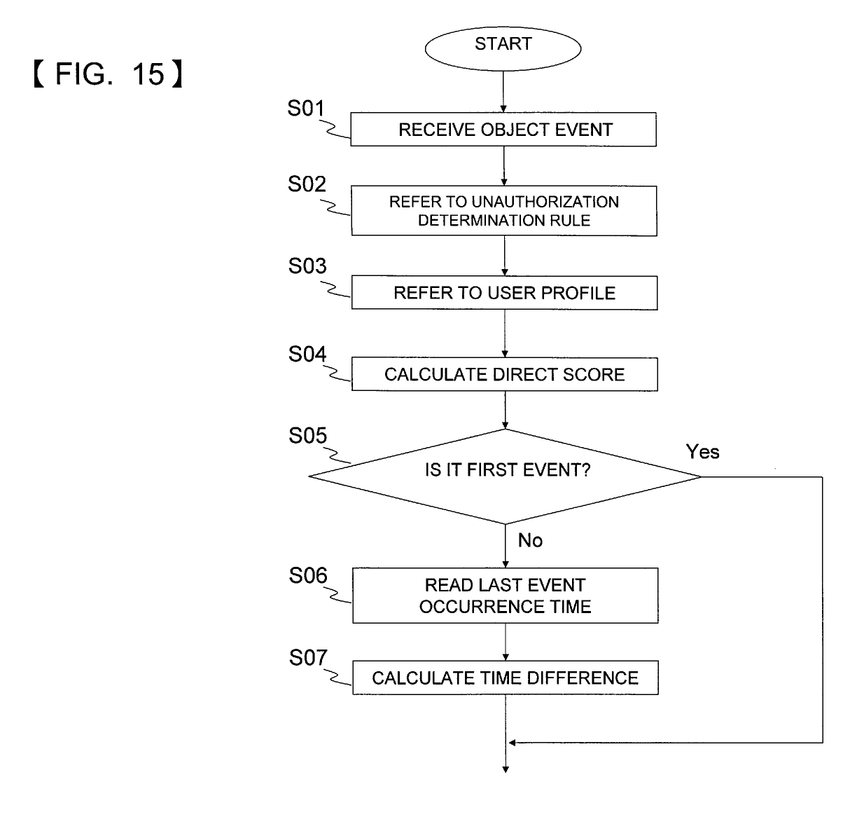

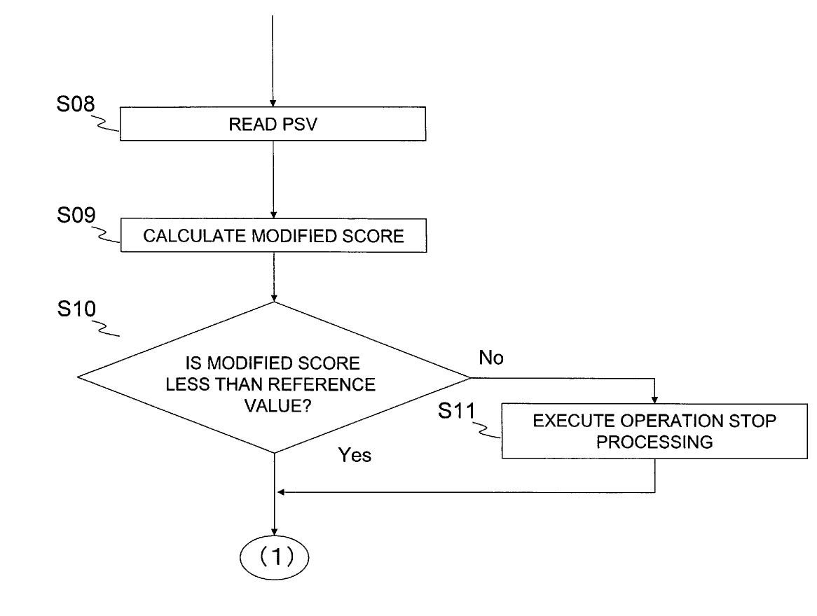

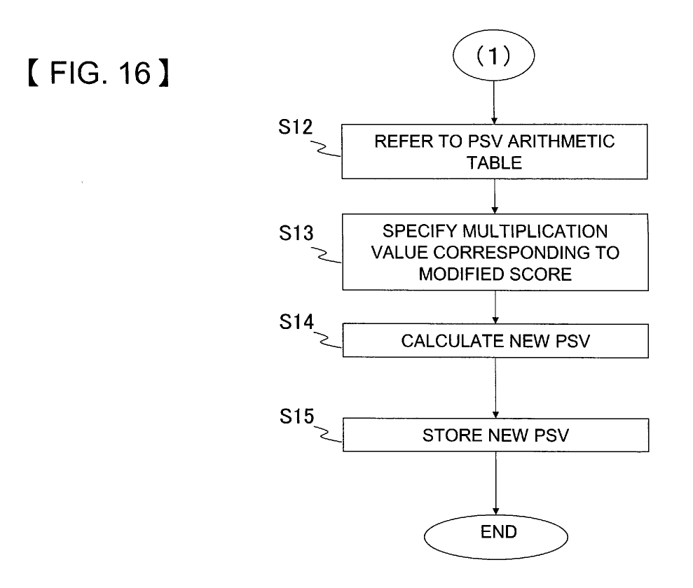

### EXPLANATIONS OF LETTERS OR NUMERALS

10: Computer

11: CPU

12: RAM

121: PSV storage unit

13: ROM

14: HDD

141: Unauthorization determination program

142: PSV arithmetic program

143: PSV arithmetic table

144: Operation log storage unit

145: User profile storage unit

146: Unauthorization determination rule storage unit

15: NIC

16: External connection bus

20: Input device

30: Output device

40: External storage device

50: Unauthorization monitoring server

1-9. (canceled)

10. A program stored on a computer readable storage medium whose execution results in a calculation of a modified score indicating a probability that a user computer operation is an unauthorized operation, wherein the user computer operation corresponds to an n^{th} event, wherein the modified score corresponds to the n^{th} event, and wherein the modified score is based on a suspicion value determined from a past computer operation of the user corresponding to an (n−1)^{th} event, the program when executed performs the following functions:
receiving the n^{th} event generated by the user computer operation;
calculating a direct score based on a probability that the user computer operation corresponding to the n^{th} event is an unauthorized operation, wherein the direct score is calculated by referring to at least one of an unauthorized rule and a profile, wherein the unauthorized rule, if used, comprises a rule that determines whether the event corresponds to an unauthorized operation, and wherein the unauthorized rule is provided by a computer being monitored or by another computer connected with the computer being monitored through a network, wherein the profile, if used, comprises a profile of events generated by past computer operations of the user, and wherein the profile is provided by the computer being monitored or by another computer connected with the computer being monitored through a network;
calculating a time difference between a time of receiving the (n−1)^{th} event and a time of receiving the n^{th} event;
calculating the modified score corresponding to the n^{th} event based on the time difference, the suspicion value corresponding to the (n−1)^{th} event, and the direct score, wherein the suspicion value is read from a memory;
if the modified score corresponding to the n^{th} event exceeds a predetermined reference value, executing a command for stopping the operation corresponding to the n^{th} event; and
updating the suspicion value corresponding to the (n−1)^{th} event to a suspicion value corresponding to the n^{th} event based on the modified score corresponding to the n^{th} event and storing the updated suspicion value in the memory.

11. The program of claim 10, wherein a multiplication value is stored in association with the modified score, and wherein the updating of the suspicion value comprises multiplying the suspicion value corresponding to the (n−1)^{th} event by the multiplication value associated with the modified score corresponding to the n^{th} event.

12. The program of claim 10 or 11, wherein the program when executed performs the further function of storing an initial value as an initial suspicion value when a login is received from the user, wherein the calculating of the modified score comprises setting the modified score to the direct score if the received event is a first event generated by the user operation following login, and wherein the updating of the suspicion value comprises updating the initial suspicion value based on the modified score calculated for the first event.

13. A computer implemented method for calculating a modified score indicating a probability that a user computer operation is an unauthorized operation, wherein the user computer operation corresponds to an n^{th} event, wherein the modified score corresponds to the n^{th} event, and wherein the modified score is based on a suspicion value determined from a past computer operation of the user corresponding to an (n−1)^{th} event, the method comprising:
receiving the n^{th} event generated by the user computer operation;
calculating a direct score based on a probability that the user computer operation corresponding to the n^{th} event is an unauthorized operation, wherein the direct score is calculated by referring to at least one of an unauthorized rule and a profile, wherein the unauthorized rule, if used, comprises a rule that determines whether the event corresponds to an unauthorized operation, and wherein the unauthorized rule is provided by a computer being monitored or by another computer connected with the computer being monitored through a network, wherein the profile, if used, comprises a profile of events generated by past computer operations of the user, and wherein the profile is provided by the computer being monitored or by another computer connected with the computer being monitored through a network;
calculating a time difference between a time of receiving the (n−1)^{th} event and a time of receiving the n^{th} event;
calculating the modified score corresponding to the n^{th} event based on the time difference, the suspicion value corresponding to the (n−1)^{th} event, and the direct score, wherein the suspicion value is read from a memory;
if the modified score corresponding to the n^{th} event exceeds a predetermined reference value, executing a command for stopping the operation corresponding to the n^{th} event; and
updating the suspicion value corresponding to the (n−1)^{th} event to a suspicion value corresponding to the n^{th} event based on the modified score corresponding to the n^{th} event and storing the updated suspicion value in the memory.

14. The method of claim 13, wherein a multiplication value is stored in association with the modified score, and wherein the updating of the suspicion value comprises multiplying the suspicion value corresponding to the (n−1)^{th} event by the multiplication value associated with the modified score corresponding to the n^{th} event.

15. The method of claim 13 or 14, wherein the method further comprises storing an initial value as an initial suspicion value when a login is received from the user, wherein the calculating of the modified score comprises setting the modified score to the direct score if the received event is a first event generated by the user operation following login, and wherein the updating of the suspicion value comprises updating the initial suspicion value based on the modified score calculated for the first event.

16. An unauthorized operation monitoring system for calculating a modified score indicating a probability that a user computer operation is an unauthorized operation, wherein the user computer operation corresponds to an n^{th} event, wherein the modified score corresponds to the n^{th} event, and wherein the modified score is based on a suspicion value determined from a past computer operation of the user corresponding to an (n−1)^{th} event, the system comprising:
a suspicion value storing means for temporarily storing the suspicion value corresponding to the (n−1)^{th} event;
an event receiving means for receiving the n^{th} event generated by the user computer operation corresponding to the n^{th} event;
an unauthorized rule storing means for storing a rule for determining whether or not the event received by the event receiving means corresponds to an unauthorized operation;
a profile storing means for storing a profile of events generated by the past computer operations of the user;
a direct score calculating means for calculating a direct store by referring to at least one of the unauthorized rule storage means and the profile storage means, wherein the direct score is calculated based on a probability that the user computer operation corresponding to the n^{th} event is an unauthorized operation;
a time difference calculating means for calculating a time difference between a time of receiving the (n−1)^{th} event and a time of receiving the n^{th} event;
a modified score calculating means for calculating a modified score based on the direct score, the time difference, and the suspicion value corresponding to the (n−1)^{th} event, wherein the calculated modified score indicates the probability that the user computer operation corresponding to the n^{th} event is an unauthorized operation;
an unauthorized operation stopping means for stopping actions corresponding to the n^{th} event if the modified score exceeds a predetermined reference value; and
a suspicion value updating means for updating the suspicion value corresponding the (n−1)^{th} event to a suspicion value corresponding to the n^{th} event dependent upon the modified score calculated by the modified score calculating means.

17. The unauthorized operation monitoring system according to claim 16, further comprising a multiplication value storing means for storing a multiplication value corresponding to the modified score calculated by the modified score calculating means, wherein the suspicion value updating means updates the suspicion value corresponding to the (n−1)^{th} event to a suspicion value corresponding to the n^{th} event based on the multiplication value.

18. The unauthorized operation monitoring system according to claim 16 or 17, further comprising a suspicion value initializing means for initializing the suspicion value to an initial value upon a login by the user, wherein the modified score calculating means sets the direct score as the modified score if the event received by the event receiving means is the first event generated by the user operation following login, and wherein the suspicion value updating means updates the initial value to a suspicion value corresponding to the first event in accordance with the modified score corresponding to the initial value.
